(19) United States
(12) Patent Application Publication
(10) Pub. No.: US 2026/0178409 A1
(43) Pub. Date: Jun. 25, 2026

(54) DATA MASKING WITH PROGRAMMABLE KERNEL EXTENSIONS

(71) Applicant: PAYPAL, INC., San Jose, CA (US)

(72) Inventors: David Daniel, Antioch, CA (US); Chetan Nadgire, Fremont, CA (US)

(21) Appl. No.: 19/000,012

(22) Filed: Dec. 23, 2024

(51) Int. Cl. G06F 9/50

(52) U.S. Cl. CPC G06F 9/505

(57) ABSTRACT

A method includes receiving a request designating an endpoint and triggering a function of a kernel extension. The function includes determining a permission of the endpoint to receive unmodified data and modifying at least part of the request based on the determined permission. The method also includes routing the request to a third computing system associated with the endpoint designated by the request.

### TECHNICAL FIELD

The present disclosure relates to programmable kernel extensions and, more particularly, to automatically masking data with programmable kernel extensions.

### BACKGROUND

In modern data environments, privacy regulations like the General Data Protection Regulation (GDPR) and the California Consumer Privacy Act (CCPA) classify certain digital information, such as internet protocol (IP) addresses, as personal data that can be used to identify a person directly or indirectly. Privacy regulations enforce restrictions on the use of such information by limiting how it can be collected, processed, stored, and shared. Some privacy regulations, such as GDPR, encourage anonymization (e.g., masking) of personally identifiable information to reduce privacy risks.

### BRIEF DESCRIPTION OF THE DRAWINGS

Certain features of the subject technology are set forth in the appended claims. However, for the purpose of explanation, several embodiments of the subject technology are set forth in the following figures, where like reference numerals refer to the same or similar features in the various figures.

FIG. 1 is a diagram of an example system, in accordance with one or more embodiments.

FIG. 2 is a diagram of example runtime environments of the routing server of FIG. 1, in accordance with one or more embodiments.

FIG. 3 is a flow chart of an example process for transmitting network traffic, in accordance with one or more embodiments.

FIG. 4 is a flow chart of an example process for masking and routing data, in accordance with one or more embodiments.

FIG. 5 is a sequence diagram of an example process for loading a programmable kernel extension, in accordance with one or more embodiments.

FIG. 6 is a block diagram view of an example computing system, in accordance with one or more embodiments.

### DETAILED DESCRIPTION

Given the growing body of data privacy regulations, entities limit the collection, processing, and storage of IP addresses to avoid regulatory violations, particularly in third-party contexts where entities may have software development kits (SDKs) that allow their applications to be placed in third-party applications. A common requirement of these regulations is anonymizing IP addresses, thus removing them from the scope of data privacy compliance concerns. However, anonymization is challenging because every client request transmits an IP address, making it necessary for businesses to employ robust IP masking measures before storing or processing this data.

In one approach, a centralized service provides a single, dedicated service for IP masking, which simplifies control and compliance but has notable limitations. The centralized service may introduce network overhead and latency as every IP address request passes through the centralized service, increasing data traffic and processing delays. Additionally, the centralized service may present scalability challenges because as traffic grows, the centralized service may become a bottleneck or require significant resources to scale effectively, potentially leading to resource strain.

In another approach, a sidecar component may be deployed alongside the main application (e.g., in a containerized environment). The sidecar approach may intercept traffic and mask IP addresses before passing them to the application. While effective in separating concerns and improving modularity, the sidecar approach may introduce network overhead with an additional routing hop and add resource consumption from running both the main application and sidecar services. Furthermore, the deployment dependency between the sidecar and main application complicates deployment pipelines, as both are managed in tandem.

In another approach, a library integration provides a direct, in-application IP masking solution, which may simplify network interactions and minimize additional resource requirements. However, the library may tightly couple the IP masking functionality with the application code, potentially leading to inconsistent implementation across different applications if they use varying library versions. The library may also reduce flexibility in configuration changes since altering the library may often require redeploying the application. Moreover, the library may add complexity to application code, increasing the development and maintenance burden.

In yet another approach and as described in further detail below, programmable kernel extensions may be used to implement IP masking functionality. This approach embeds IP masking logic directly within the operating system kernel, enabling efficient data manipulation without the overhead of additional network hops or application-layer processes. By executing IP masking at the kernel level, this approach may address the challenges of the other approaches, offering platform-agnostic and high-performance data handling. Programmable kernel extensions may enable developers to introduce custom code into the kernel, altering the kernel's behavior or adding new functions without compromising security or stability. Using tools like extended Berkely packet filter (eBPF), developers can hook into system-level events directly within the kernel, intercepting IP addresses as they pass through the network stack. This configuration may enable the IP masking process to execute immediately upon data reception so that only masked IP addresses reach downstream applications or storage locations that are not permitted to receive unmasked IP addresses.

Technical benefits of using programmable kernel extensions for IP masking include minimal infrastructure overhead. By embedding IP masking directly in the kernel, this approach reduces the need for separate service components, sidecars, or libraries at the application level. This approach also minimizes the complexity of infrastructure and reduces resource consumption associated with other approaches. Since IP masking occurs directly within the kernel's network stack, this approach may also reduce network overhead and processing latency. IP addresses may be masked immediately without the need for additional hops or inter-process communication, leading to a faster and more streamlined data flow. Additionally, eBPF-based kernel extensions may work across different operating systems and platforms, offering a platform-agnostic solution. This flexibility provides consistent IP masking functionality regardless of the environment without requiring extensive reconfiguration or platform-specific adaptations. Furthermore, programmable kernel extensions may execute in a restricted and secure environment, which limits potential risks to system stability or security. Because eBPF programs may be verified before execution, the kernel can safely load them without risking untrusted or faulty code execution, maintaining a secure IP masking solution within the kernel itself. Lastly, kernel extensions can be updated more independently, unlike application libraries or sidecar configurations that require version alignment and redeployment for updates. This reduces dependency management complexity and allows for quicker updates if IP masking requirements change.

Although the discussion of the programmable kernel extension approach is with respect to masking IP addresses, it should be understood that the programmable kernel extension approach may be utilized to perform any other kind of operation (in addition to or instead of masking) with respect to any other kind of data (in addition to or instead of IP addresses).

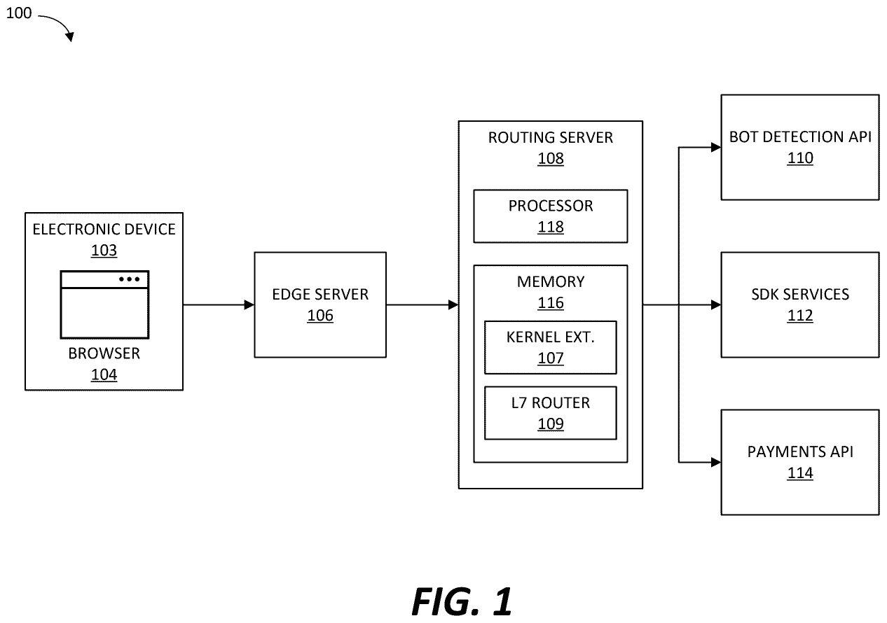

Referring now to the drawings, FIG. 1 is a diagram of an example system 100. Not all of the depicted components may be used in all embodiments, and one or more embodiments may include additional, fewer, or different components than those shown in the figure. Variations in the arrangement and type of components may be made without departing from the spirit or scope of the claims as set forth herein.

The system 100 may include a web browser 104 running on an electronic device 103 of a user, an edge server 106, a routing server 108, a bot detection API 110, SDK services 112, and a payments API 114. In general, the electronic device 103 may make network requests intended for one or more of the bot detection API, the SDK services 112, and the payments API 114. The edge server 106 and routing server 108 may route the user's requests and, as part of such routing, may mask the user's IP address.

The user electronic device 103 may be a smartphone, laptop, desktop, or other physical or virtual electronic device. The user electronic device 103 may include a web browser 104. The browser 104 may be a standalone browser or an in-application browser that may be used to initiate requests with other applications (e.g., web applications) running on another part of a network (e.g., the internet). The browser 104 may act as the user's interface with the network, sending requests to various web services. Each request may include the IP address of the electronic device 103, which can be used for analytics, personalization, or security checks. Accordingly, the browser 104 and/or the user electronic device 103 may be the origin of an IP address that is subject to masking as the request traverses through the network.

The edge server 106 may be associated with (e.g., may route traffic for or otherwise support) an online platform (e.g., website, service, API, etc.). The edge server 106 may be or may include a rack-mounted server, desktop, or other physical or virtual electronic device. The edge server 106 may be a server positioned at the “edge” of the network, close to end-users (e.g., within a content delivery network (CDN) or geographically distributed infrastructure). The edge server 106 may host one or more software or service applications. The applications may perform specific tasks, such as caching static assets, filtering requests, enforcing security policies, handling application logic, etc. In the system 100, the edge server 106 may be the first point of contact for incoming requests from the electronic device 103. The edge server 106 may populate the IP address of the electronic device 103 within the request header, making the IP address available for downstream processing. The edge server 106 may obtain the IP address of the electronic device 103 from the network layer (layer 3 or “L3”) metadata (e.g., source address field) in the IP packet used to transmit the request. The edge server 106 may add the IP address of the electronic device 103 to the application layer (layer 7 or “L7”) by, for example, including the IP address in the HTTP request header. This may be done for providing the IP address to downstream devices or applications, which may not have direct access to network layer information.

The routing server 108 may also be associated with the online platform. The routing server 108 may be a rack-mounted server, desktop, or other physical or virtual electronic device. The routing server 108 may include at least one processor 118 and at least one non-transitory, computer-readable memory 116 storing instructions that, when executed by the processor, cause the routing server 108 to perform one or more methods, processes, operations, etc. of this disclosure.

The routing server 108 may include a layer 7 (L7) router 109 application (e.g., load balancer or reverse proxy) that serves as an intermediary for directing network requests to appropriate backend services based on the respective context of the requests, where the context may include a uniform resource locator (URLs) included in the request, request headers, and/or specific rules (e.g., predefined rules for how requests should be preprocessed before routing). The L7 router 109 may operate at the application layer of the routing server 108, making them suitable to inspect and/or manipulate hypertext transfer protocol/hypertext transfer protocol secure (HTTP/HTTPS) requests.

The bot detection API 110, SDK services 112, and payments API 114 each may be associated with the online platform. The bot detection API 110 may include hardware and/or software configured to analyze incoming traffic to detect and block automated or malicious activity. To perform accurate bot detection, the bot detection API 110 may use IP address information to identify and flag suspicious behavior patterns associated with specific IPs. The SDK services 112 may include hardware and/or software configured to perform operations associated with elements of the application embedded in other (e.g., third-party) websites or applications (e.g., to provide tracking, analytics, or other auxiliary functions). SDKs may operate in third-party contexts and may be subject to stringent privacy regulations, such as in regions governed by laws like GDPR and CCPA. The payments API 114 may include hardware and/or software configured to handle financial transactions, including performing user authentication, fraud checks, and/or other security measures. The payments API 114 may rely on unmasked IP addresses to assess transaction risk, comply with anti-money laundering (AML) and anti-fraud protocols, meet regulatory demands for financial transactions, etc. It should be understood that the APIs 110, 114 and services 112 are merely example backend systems and that kernel-based IP masking according to the present disclosure may find use with greater or fewer than three backend systems.

The routing server 108 may include one or more kernel extensions 107 (e.g., an eBPF-based program). The routing server 108 may invoke to perform pre-programmed operations in the kernel space of the routing server 108, including but not limited to IP address masking. In response to receiving a request from the edge server 106, the routing server 108 may use programmable kernel logic to examine the target destination of the request, decide whether to mask the IP address (e.g., based on the target destination), and mask the IP address when appropriate before routing the request to its destination. For example, if the destination is a bot detection API 110, the routing server 108 may mask the IP address and transmit it in masked form, as the API 110 may rely on identifying unique users for bot detection. If the destination is an SDK service 112, the routing server 108 may mask the IP address and transmit it in masked form because the SDK service does not require identifiable IP addresses and may have regulator restrictions. In contrast, if the destination is a payments API 114, the routing server 108 may not mask the IP address and may transmit it in unmasked form, as the payments may require full IP information for risk assessment, fraud detection, regulatory compliance, etc.

By integrating IP masking directly at the kernel level, the routing server 108 can process requests with minimal additional latency or overhead. The kernel extension allows IP masking to occur seamlessly and efficiently without passing the request to separate processes, services, or devices.

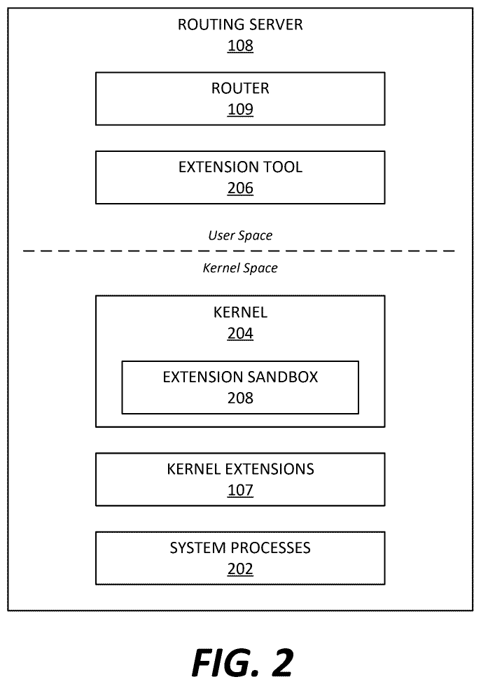

FIG. 2 is a diagram of the runtime environments of the routing server 108. The runtime environments of the routing server 108 may be divided into user space and kernel space. This separation allows the routing server 108 to efficiently handle high-level application logic and low-level system operations while maintaining security, stability, and performance.

The user space may be where application-level processes run. Application-level processes may allow for more customizability while being limited in their ability to interact with the hardware and system process 202 (e.g., processes of the operating system). Application-level processes may include the L7 router 109 application, which may include the logic that determines how traffic is routed, managed, and/or forwarded. To interface with the hardware of the routing server 108 (e.g., to transmit data via a communication interface), the L7 router 109 may utilize system calls (e.g., functions, methods) that invoke one or more system processes 202 to interface with the hardware on behalf of the L7 router 109. Application-level processes may also include a kernel extension tool 206 (e.g., bpftool) that allows the modification of kernel extensions 107 and/or loading of kernel extensions 107 into the kernel 204.

The kernel space may be a privileged part of the operating system of the routing server 108 where the kernel 204 runs. The kernel 204 may be a part of the operating system that has direct access to the hardware resources of the routing server 108 and provides system-level services to applications. For example, the kernel 204 may manage the hardware resources (e.g., CPU, memory, I/O devices, etc.) and/or provide access to the hardware resources to applications in the user space (e.g., provides extension tool 206 access to the kernel space for loading kernel extensions 107). The system processes 202 may be programs that run in the kernel space and are managed by the kernel 204. The system process 202 may be specific tasks instantiated by the kernel to manage and provide hardware resources and system services, such as handling the receiving and/or transmitting of network packets (e.g., via system calls recv( ) and send( )).

The kernel 204 may include a programmable interface for augmenting kernel behavior dynamically. The programmable interface may be a sandbox environment and may be referred to herein as a kernel extension sandbox 208. The kernel extension sandbox 208 may be part of the runtime environment of the kernel 204 that allows the kernel 204 to execute kernel extensions 107 (e.g., eBPF programs), which are loaded into the kernel space and/or the kernel 204 (e.g., via the bpf( ) system call) and attached to an event (e.g., a system process 202). The kernel extension sandbox 208 provides a restricted runtime environment within the kernel 204, isolating programs running in the kernel extension sandbox 208 from the core operations of the kernel 204 and allowing only access to predefined resources (e.g., eBPF maps, helper functions), thus maintaining the stability of the kernel 204 while allowing the kernel 204 to perform custom operations defined by the extensions 107.

To illustrate the use of kernel extensions 107, a user-space program (e.g., extension tool 206) may use a system call (e.g., bpf( )) to load kernel extension 107 bytecode into the kernel space. The kernel 204 may include a verifier to check the kernel extension 107 for safety and correctness before admitting it to the kernel 204 (e.g., kernel extension sandbox 208 of the kernel 204). The user-space program (e.g., extension tool 206) may attach the loaded kernel extension 107 to a specific hook (e.g., a system process 202 such as a network interface). When the attached event is triggered, the kernel 204 may call the kernel extension sandbox 208, passing the relevant execution context (e.g., a network packet structure or system call arguments). The kernel extension sandbox 208 may interpret or execute the bytecode of the kernel extension 107 inline within the kernel 204, applying logic defined by the kernel extension 107. After the kernel extension 107 finishes execution, the kernel extension sandbox 208 may return control to the kernel 204, which may resume its previous operation.

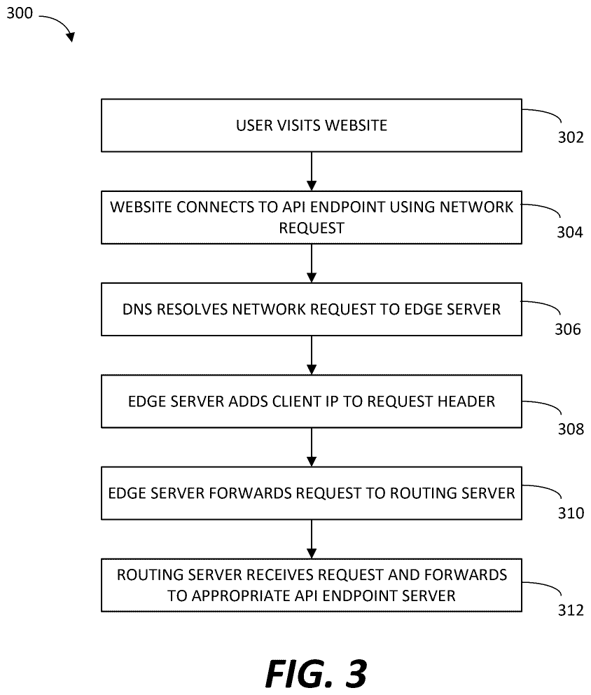

FIG. 3 is a flow chart of an example process 300 for transmitting network traffic. For explanatory purposes, FIG. 3 is described herein with reference to the system 100 of FIG. 1, and thus the process 300 may be a computer-implemented method. However, this is merely illustrative, and features of the system 100 may be performed by any other system for implementing the subject technology. Additionally, for explanatory purposes, the operations of the process 300 are described herein as occurring sequentially or linearly. However, multiple operations of the process 300 may occur in parallel. The operations of the process 300 need not be performed in the order shown, and one or more operations of the process 300 need not be performed or can be replaced by other operations.

At operation 302, the electronic device 103 visits (e.g., accesses) a website associated with an online platform. The online platform may be an application, service, API, SDK, and/or the like. The website may be a first-party website (e.g., a website of the online platform) or a third-party website with an embedded element (e.g., chat widget, content sharing button, etc.) associated with the online platform. The electronic device 103 may visit the website via an application (e.g., the web browser 104) running on the electronic device 103. For example, the electronic device 103 (e.g., via one or more user inputs) may visit the online platform's primary website (e.g., located at a domain under control of the platform), or a third-party website located at a domain that is not under the platform's control and where the platform's payments widget is embedded.

At operation 304, in response to interactions between the web browser 104 and the website (e.g., page load, user input, etc.), the electronic device 103 may generate and transmit one or more requests to the platform's backend endpoints (e.g., APIs 110, 114, and/or services 112). Generating and transmitting requests may occur regardless of whether the platform owns the website or operates as a third-party service. For example, user interaction with an embedded payments button on the website may cause the web browser 104 to send a request to the platform's payments API 114 to initiate a payment. In another example, user interaction with an embedded social login widget on the website may cause the web browser 104 to send a request to the platform's bot detection API 110 to verify that the user is a human. In another example, an analytics service integrated into the website may cause the web browser 104 to send a request to an SDK service 112 for tracking user interactions.

The requests generated and transmitted by the electronic device 103 to the platform's backend endpoints may include information such as a source address and a destination address so that the electronic device 103 and/or other devices know where to route the requests.

At operation 306, the electronic device 103 may resolve (e.g., map, convert, transform) a destination domain name specified in the request (e.g., by a domain name system (DNS)) to an IP address. The resolved IP address enables the electronic device 103 (or any other electronic device with the request) to direct the request to an edge server 106, which may be close to the user's geographic location for reduced latency.

At operation 308, the edge server 106 may, in response to receiving the request, inspect and/or modify the request. Modifying the request may include adding the client's IP address (the IP address of the electronic device 103) to the request header if it is not already included. This way, the IP address may be utilized by downstream processes, such as fraud detection, personalization, and analytics. For example, the edge server 106 may populate a header attribute (e.g., X-Forwarded-For) with the client's IP address. If the request already includes an IP address (e.g., from a proxy), the edge server 106 may append the client IP address to the header.

At operation 310, the edge server 106 may forward the request (e.g., with the client's IP address included in the header) to the routing server 108 for modifying the request and/or routing the request to the target destination.

In some embodiments, the electronic device 103 may provide the request directly to the routing server 108, and operations 308 and 310 may be skipped. For example, the domain name may resolve to the IP address of the routing server 108.

At operation 312, the routing server 108 may route (e.g., direct) the request to the target endpoint (e.g., payments, authentication, analytics) based on routing logic stored at the routing server 108 (e.g., associated with router 109). In some embodiments, the routing server 108 may modify the request to mask (e.g., remove, replace, modify, anonymize) sensitive information (e.g., IP addresses), if the request includes sensitive information that should not be provided to the target endpoint. The routing logic applied by the routing server 108 for modifying and/or directing the request to the target endpoint (e.g., server) is discussed in further detail with respect to process 400 below.

In various examples of operations 310 and 312, the edge server 106 may forward a request for api.example.com/buy to the routing server 108, which may route the request to a payments API; the edge server 106 may forward a request for api.example.com/login to the routing server 108, which may route the request to an authentication API; the edge server 106 may forward a request for api.example.com/track to the routing server 108, which may route the request to an SDK service 112 for analytics.

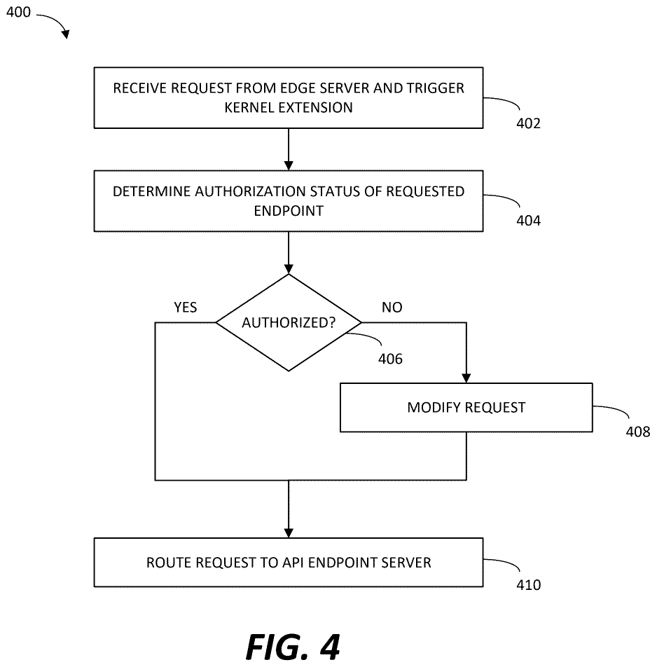

FIG. 4 is a flow chart of an example process 400 for masking and routing data. For explanatory purposes, FIG. 4 is described herein with reference to the system 100 of FIG. 1, and thus the process 400 may be a computer-implemented method. In some embodiments, some or all of the process 400 may be performed by the routing server 108. However, description of the process 400 with reference to the components of system 100 is merely illustrative, and features of the system 100 may be performed by any other system for implementing the subject technology. Additionally, for explanatory purposes, the operations of the process 400 are described herein as occurring sequentially or linearly. However, multiple operations of the process 400 may occur in parallel. The operations of the process 400 need not be performed in the order shown, and one or more operations of the process 400 need not be performed or can be replaced by other operations.

At operation 402, the routing server 108 may receive a request from the electronic device 103 (e.g., forwarded by the edge server 106). The request may include the IP address of the electronic device 103 (e.g., via X-Forwarded-For or similar header fields). The routing server 108 may receive the request, inspect its metadata (including headers), and/or determine how the request should be handled.

The routing server 108 may include one or more programmable kernel extensions 107 (e.g., based on eBPF). In response to receiving the request (e.g., one or more network packets containing the request), the routing server 108 (e.g., the router 109) may trigger a system call to handle the packet. The system call may trigger a kernel extension (e.g., kernel extension 107) that is attached to the system call and that performs operations, such as inspecting the target API endpoint, analyzing headers, and/or making decisions on data modification. The kernel extension's interception of the request enables the routing server 108 to apply fine-grained control over incoming requests without requiring complex application-layer processing, improving efficiency and scalability. Additionally, the kernel-level interception minimizes latency by handling operations closer to the hardware, avoiding the need to pass requests through multiple application layers.

For example, consider a scenario where a user interacts with a third-party website that embeds a payment platform's “Buy Now” button. When the user interacts with the button, the user's browser 104 sends an HTTP request for https://api.example.com/buy to initiate a payment. A DNS resolves the domain to the IP address of the edge server 106. The edge server 106 adds the IP address of the electronic device 103 to the X-Forwarded-For header of the request and forwards the request to the routing server 108. The routing server 108 receives the request responsive to a system call (e.g., recv( )) intended to trigger a kernel extension of the routing server 108. The kernel extension may intercept the system call and, in response, may analyze and/or modify the packet headers included in the request. For example, the kernel extension may access a buffer associated with the incoming packet during or just before the execution of the system call to analyze and/or modify the incoming packet and, after execution of the kernel extension, the system call may access the buffer to further analyze and/or modify the incoming packet.

In some embodiments, the kernel extension may intercept the system call as a result of one or more mechanisms, such as eBPF probes or hooks, “hooking” the kernel extension into system calls and/or other related kernel events. Such a probe or hook may monitor kernel events for specific events and trigger specific functionality in response to the specific events. Here, a probe or hook may monitor kernel events for a system call or other event that includes an IP address and, in response, trigger the kernel extension. As a result, the hook may act as a trigger that causes custom logic defined (e.g., as functions) in the kernel extension to execute whenever a relevant system call is made. This enables interception to occur transparently to the user-space application.

One or more kernel extensions may be hooked to system calls in the routing server 108 during an installation process described further below with respect to process 400. The installation process enables the modification of kernel behavior dynamically without requiring significant downtime (e.g., server restarts, kernel recompilation, etc.).

At operation 404, the kernel extension may determine the authorization status of the requested endpoint. Specifically, the kernel extension may determine whether the requested endpoint is authorized to receive unmodified IP addresses by evaluating the request against preconfigured authorization rules.

In order to determine the authorization status of the requested endpoint, the kernel extension may inspect the received request, such as its target URL or API path (e.g., /buy, /track, /auth) and/or header information (e.g., Host, X-Forwarded-For). The inspection may involve parsing the request and cross-referencing its details against a set of predefined masking permissions stored in a configuration file or other data store format (e.g., in the kernel extension or elsewhere in the kernel space of the routing server 108). The permissions may dictate whether the endpoint should receive the user's original IP address or an anonymized version.

The masking permissions may map respective endpoints to a masked or unmasked permission. For example, the bot detection API 110 may be authorized (e.g., permitted) to receive unmodified IP addresses to analyze traffic patterns and detect malicious activity; the SDK services 112 may be unauthorized to receive unmodified IP addresses due to privacy regulations; and the payments API 114 may be authorized to receive unmodified IP addresses because fraud detection and regulatory compliance may rely on accurate geolocation and user identification.

The masking permissions may be manually defined. A masking permission file may include masking permissions (e.g., input by a user) and may be included with the kernel extension. When the kernel extension is loaded into the kernel space, the loading process may include creating or updating a masking permission in the kernel space according to the masking permission file. Additionally or alternatively, permission engines, tags, machine learning models, or other tools may be used to automate the creation or updating of permissions, as described below.

In some embodiments, in addition to or instead of manually defining permissions for each endpoint, a permission engine may be used to dynamically evaluate requests and automatically generate masking permissions. The permission engine may decide whether an endpoint is authorized to receive unmodified IP addresses considering contextual factors such as endpoint name, client name, user roles, request time, and/or region, and generate a masking permission for the endpoint based on the decision. This way, in response to receiving a request that targets an endpoint that does not have a predefined permission, the permission engine may dynamically create a permission. For example, the permission engine may allow endpoints with security or finance names (e.g., “/buy”) to receive unmodified IP addresses.

In some embodiments, in addition to or instead of manually defining permissions for each endpoint, a machine learning model may be trained on historical request data and compliance rules to classify endpoints as authorized or not authorized to receive unmodified IP addresses and the permission engine may generate a permission based on the classification. The model may predict whether an endpoint requires anonymized or unmodified IP addresses based on usage patterns and regulatory constraints. The model might infer that endpoints primarily accessed via third-party websites (e.g., SDKs) and/or from certain jurisdictions should always receive anonymized IPs.

In some embodiments, in addition to or instead of manually defining permissions for each endpoint, endpoints may be tagged (e.g., by the entity maintaining the endpoint) with metadata indicating their IP handling requirements (e.g., “ip_permission: unmodified” or “ip_permission: anonymized”). The routing server 108 may build and maintain a cache (e.g., a database) of metadata based on previous communications with the endpoints, which the kernel extension may reference to determine the authorization status of the requested endpoint. For example, the routing server 108 may receive metadata from a “/track” endpoint indicating a tag of “ip_permission: anonymized” and from a “/buy” endpoint indicating a tag of “ip_permission: unmodified”, both of which may be stored used for defining permissions. If an endpoint does not provide a tag, the kernel extension may reference predefined permissions or dynamically generate a permission for endpoint (e.g., based on the context of the request).

At operation 406, if the target endpoint is authorized to receive unmodified IP addresses, the process 400 may proceed to operation 410; otherwise, the process 400 may proceed to operation 408.

At operation 408, in response to determining that the endpoint is not authorized to receive one or more aspects of the request in an unmodified form, the kernel extension may modify the request. Modifying the request may include transforming the incoming request to comply with privacy regulations and/or endpoint-specific requirements. When the kernel extension determines that the target API endpoint is not authorized to receive unmodified IP addresses, the kernel extension may mask (e.g., anonymize, obfuscate, modify) the user's IP address to comply with laws like GDPR or CCPA while maintaining operational functionality. Masking may be performed in place (e.g., directly on the request data) or may be performed by replacing some or all of the request (e.g., with a modified version of the request). The IP address may be masked such that enough information is retained for operational use (e.g., analytics) while rendering the IP address not personally identifiable.

In some embodiments, the kernel extension may mask the IP address by truncation. Truncation may involve masking part of the IP address to remove specificity. For example, an original IPv4 address may be “192.0.2.1”, which may be anonymized to “192.0.0.0”, and an original IPv6 address may be “2001:db8:85a3::8a2e:370:7334”, which may be anonymized to “2001: db8::”.

In some embodiments, the kernel extension may mask the IP address by hashing. In this approach, the IP address may be hashed by inputting the IP address to a cryptographic algorithm (e.g., SHA-256 or HMAC) to create a pseudonymous identifier from which the original IP address cannot be derived. For example, an original IP address may be “192.0.2.1”, which may be hashed to “6b1b36cbb04b41490bfc0ab2bfa26f86”. While hashing retains uniqueness for analytical purposes, hashing eliminates direct identification of the user.

In some embodiments, the kernel extension may mask the IP address by tokenization. Tokenization may involve replacing the IP address with a unique, randomly generated token that is mapped to the original IP in a secure lookup table (e.g., stored in the kernel space of the routing server 108). For example, an original IP address may be “192.0.2.1”, which may be mapped to a token “TOKEN12345”. This approach allows internal systems to reference the original IP address without exposing it externally.

In some embodiments, the target endpoint may not utilize the IP address, in which case the kernel extension may remove the IP address in the request, such as by nullifying the header field value or by removing the header field. For example, if the request includes in its header “X-Forwarded-For: 192.0.2.1”, the header may be modified to “X-Forwarded-For: Null” or the X-Forwarded-For field may be removed from the header.

Although the discussion herein is primarily with respect to IP address, the embodiments described herein may be applied to any form of personally identifiable information, such as passport numbers, license numbers, phone numbers, email addresses, physical addresses, geolocation coordinates, and/or the like.

At operation 410, the routing server 108 may forward the processed request—potentially modified to comply with privacy regulations—to the proper endpoint (e.g., designated by the request). The routing server 108 may act as the intermediary between the upstream edge server 106 (or client) and the downstream destination services (e.g., APIs 110, 114 and services 112). The destination endpoints may be located within the same or different infrastructure (e.g., cloud infrastructure, data center) or an external system (e.g., managed by a third party). The forwarding process helps each request arrive at the correct endpoint with the proper information in its proper form (e.g., anonymized or original).

The routing server 108 may determine the appropriate destination for the request based on factors such as URL path, request headers, load balancing policies, and/or the like. URL path may specify the destination based on identifiers in the URL of the request. For example, requests including paths such as “/auth” may be routed to an authentication service, “/buy” to a payments API, and “/track” to an SDK service. Headers such as “Host” or customer headers can indicate the intended destination. Load balancing may distribute requests across multiple servers for scalability and availability.

Once the appropriate destination is determined, the routing server 108 may forward the request to the determined endpoint. The transmission may leverage networking protocols such as HTTP/HTTPS, gRPC, MQTT, WebSocket, and/or the like.

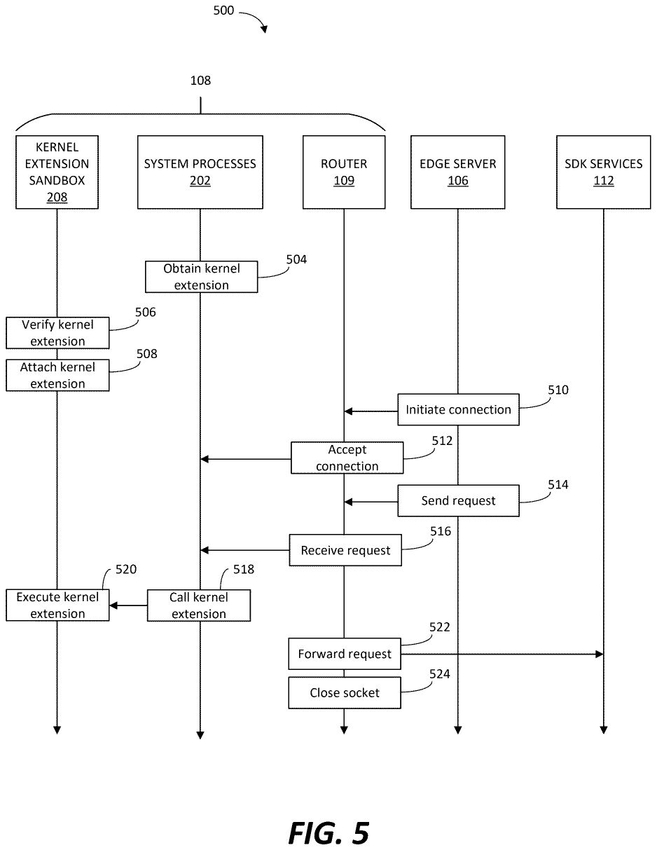

FIG. 5 is a sequence diagram of an example process 500 for loading a programmable kernel extension to a kernel of a computing system. For explanatory purposes, FIG. 5 is described herein with reference to the system 100 of FIG. 1, and thus the process 500 may be a computer-implemented method. However, this is merely illustrative, and features of the system 100 may be performed by any other system for implementing the subject technology. Additionally, for explanatory purposes, the operations of the process 500 are described herein as occurring sequentially or linearly. However, multiple operations of the process 500 may occur in parallel. The operations of the process 500 need not be performed in the order shown, and one or more operations of the process 500 need not be performed or can be replaced by other operations.

At operation 504, a system process 202 of the routing server 108 may obtain (e.g., load, access, download, receive) a programmable kernel extension (e.g., file, script). Kernel extensions (e.g., kernel extension 107), such as those built using eBPF, may be written in a programming language (e.g., C or Rust) and compiled into a format that the kernel (e.g., kernel 204) can interpret. The kernel extension may be compiled in the user space, transforming the human-readable programming language into a set of machine-readable instructions. The system process 202 may be invoked by a tool (e.g., bpftool) or system call (e.g., bpf( )) to obtain the kernel extension from the user space to the kernel space of the routing server 108.

The kernel extension may include a set of masking permissions loaded into the kernel space in a manner similar to the kernel extension (e.g., with bpftool) to create or update a set of masking permissions in the kernel space that may be referenced by the kernel extension. For example, a hash map could associate endpoint identifiers (e.g., IP-port pairs) with permission flags, which may indicate whether an endpoint is or is not permitted to receive unmodified data (e.g., IP addresses). For example, a set of permissions may include map entries “203.0.113.10:443→allow_non_anonymized=1” (payments API 114) and “198.51.100.5:80→allow_non_anonymized=0” (SDK service 112).

At operation 506, an extension verifier may analyze the kernel extension to verify that the kernel extension adheres to predetermined safety and efficiency criteria. The verifier may perform control flow analysis to verify, for example, that the kernel extension does not contain loops or other unbounded execution patterns. The verifier may also or instead validate that the kernel extension only accesses memory regions explicitly allowed by the kernel. The verifier may also or instead check that the kernel extension does not exceed stack or register usage limits, which could lead to kernel instability or performance degradation. The verifier may also or instead verify that the kernel extension adheres to a restricted instruction set and avoids operations that could crash the kernel, such as invalid arithmetic operations or illegal jumps.

At operation 508, the kernel extension may attach its functions to one or more system calls of the routing server 108. Attaching a custom kernel extension function to a system call causes the custom kernel extension function to execute whenever the targeted system call is invoked. The recv( ) system call, for instance, may be used to receive data from a network connection. By attaching a kernel extension function, the functionality of the system call can be extended for use cases such as logging received messages, modifying incoming data, and/or applying filters for security and compliance purposes.

Kernel extension functions can be attached to system calls through hooks provided by tracepoints, kprobes, or Linux security modules (LSMs), depending on the desired level of control. Tracepoints may provide predefined instrumentation points, while kprobes may offer dynamic, event-driven attachment at almost any kernel extension function. For security policies, LSM hooks enable monitoring and controlling access to kernel objects. For example, to mask personally identifiable information from all incoming data processed by recv( ), a kernel extension function can be attached using a kprobe. The attachment enables the kernel extension to intercept and act on calls to the recv( ) system call whenever it is invoked.

At operation 510, the edge server 106 may initiate a connection with the routing server 108. The edge server 106, acting as a client, may use the connect( ) system call to establish a connection to the routing server 108.

At operation 512, the routing server 108 may use the accept( ) system call to cause a system process 202 to accept the incoming connection from the edge server 106. Although discussion of process 500 is in part with respect to edge server 106, it should be understood that the operations of process 500 are also applicable to other electronic devices in place of the edge server 106, such as electronic device 103 directly communicating with the routing server 108. In some embodiments, a kernel extension function may be attached to the accept( ) system call, for example, to log connections when the accept( ) system call is invoked.

At operation 514, the edge server 106 and router 109 of the routing server 108 may exchange data over the newly created connection. The edge server 106 may use the send( ) system call to transmit a request through the connection. The edge server 106 may prepare the request in a buffer in memory, including the payload such as an HTTP header, API call parameters, and/or serialized application data. For example, the edge server 106 may send (e.g., forward) a request from the electronic device 103 to the routing server 108. The request may include the IP address of the electronic device 103 (e.g., via X-Forwarded-For or similar header fields).

At operation 516, the router 109 may use the recv( ) system call to cause a system process 202 to receive the request via the connection. The recv( ) system call may block or poll until the request arrives, reading it into a buffer in memory. The buffer may hold the incoming request for processing, such as parsing the HTTP header, extracting routing instructions, or passing the payload to downstream functions.

At operation 518, before executing the recv( ) system call, the system process 202 may cause the kernel extension sandbox 208 to execute one or more functions of the kernel extension attached to the recv( ) system call.

At operation 520, the kernel extension sandbox 208 may execute the kernel extension function attached to the recv( ) system call. The kernel extension function may manipulate the request, for example, to anonymize personally identifiable information (e.g., IP addresses), as described above with respect to process 400. In response to the kernel extension function completing its execution, the system process 202 may resume handling the recv( ) system call on the modified or unmodified request.

At operation 522, after the system process 202 handles the recv( ) system call, the router 109 may continue processing the request based on its application logic (e.g., L7 routing, load balancing, and/or other logic). The router 109 may forward the request to the destination specified by the request, in this case SDK services 112. The router 109 may use the send( ) system call to cause a system process 202 to forward the processed request to the SDK services 112.

At operation 524, the router 109 may use the close( ) system call to cause a system process 202 to close the connection when the communication with the target endpoint is complete or when maintaining the socket is no longer necessary. For protocols like HTTP/1.0, where each request is handled in a separate connection, the routing server 108 may close the socket immediately after forwarding the request or receiving a response from the target endpoint and sending it back to the client. This approach minimizes resource usage by keeping sockets open as long as necessary.

In some embodiments, a kernel extension function may be attached to the close( ) system call, for example, to log the end of a connection when the close( ) system call is invoked.

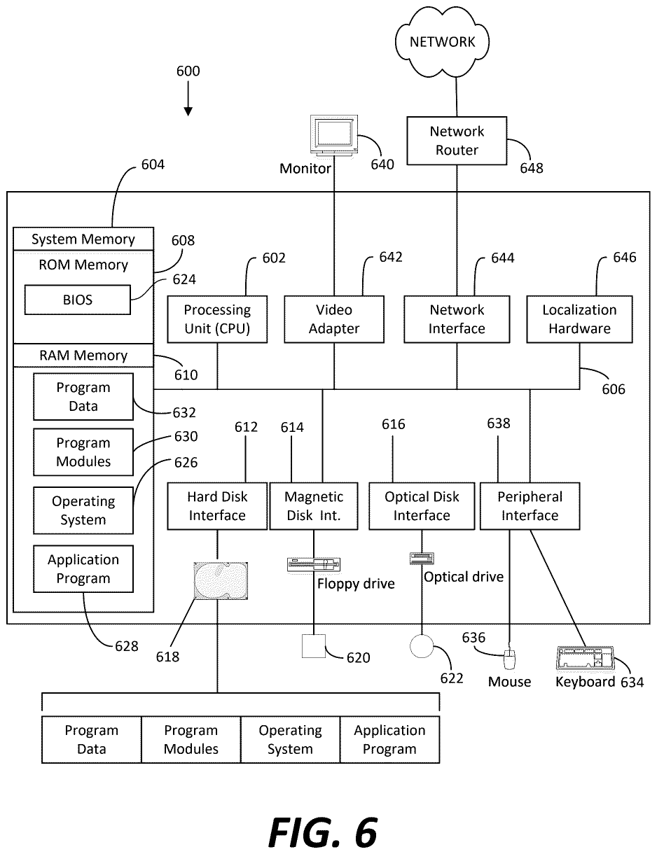

FIG. 6 is a block diagram of an example computing system 600. A computing system 600 may be a desktop computer, laptop, smartphone, tablet, or any other electronic device having the ability to execute instructions, such as those stored within a non-transitory computer-readable medium. Furthermore, while described and illustrated in the context of a single computing system 600, those skilled in the art will also appreciate that the various tasks described herein may be practiced in a distributed environment having multiple computing systems 600 linked via a local or wide-area network in which the executable instructions may be associated with and/or executed by one or more of multiple computing systems 600.

In its most basic configuration, the computing system 600 may include at least one processing unit 602 and at least one memory 604, which may be linked via a bus 606. Depending on the exact configuration and type of computing system environment, memory 604 may be volatile (such as RAM 610), non-volatile (such as ROM 608, flash memory, etc.) or some combination of the two.

Computing system 600 may have additional features and/or functionality. For example, computing system 600 may also include additional storage (removable and/or non-removable) including, but not limited to, magnetic or optical disks, tape drives and/or flash drives. Such additional memory devices may be made accessible to the computing system 600 by means of, for example, a hard disk drive interface 612, a magnetic disk drive interface 614, and/or an optical disk drive interface 616. As will be understood, these devices, which would be linked to the system bus 606, respectively, allow for reading from and writing to a hard drive 618, reading from or writing to a removable magnetic disk 620, and/or for reading from or writing to a removable optical disk 622, such as a CD/DVD ROM or other optical media. The drive interfaces and their associated computer-readable media allow for the non-volatile storage of computer-readable instructions, data structures, program modules and other data for the computing system 600. Those skilled in the art will further appreciate that other types of computer-readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer-readable instructions, data structures, program modules or other data. Any such computer storage media may be part of computing system 600.

A number of program modules may be stored in one or more of the memory/media devices. For example, a basic input/output system (BIOS 624), containing the basic routines that help to transfer information between elements within the computing system 600, such as during start-up, may be stored in ROM 608. Similarly, RAM 610, hard drive 618, and/or peripheral memory devices may be used to store computer executable instructions comprising an operating system 626, one or more applications programs 628, other program modules 630, and/or program data 632. Still further, computer-executable instructions may be downloaded to the computing system 600 as needed, for example, via a network connection. The applications programs 628 may include, for example, bot detection logic (e.g., for a bot detection API 110), SDK service logic (e.g., for SDK services 112), and/or payments logic (e.g., for payments API 114).

An end-user may enter commands and information into the computing system 600 through input devices such as a keyboard 634 and/or a pointing device 636. While not illustrated, other input devices may include a microphone, a joystick, a game pad, a scanner, etc. These and other input devices would typically be connected to the processing unit 602 by means of a peripheral interface 638 which, in turn, would be coupled to bus 606. Input devices may be directly or indirectly connected to processing unit 602 via interfaces such as, for example, a parallel port, game port, firewire, or a universal serial bus (USB). To view information from the computing system 600, a monitor 640 or other type of display device may also be connected to bus 606 via an interface, such as via video adapter 642. In addition to the monitor 640, the computing system 600 may also include other peripheral output devices, not shown, such as speakers and printers.

The computing system 600 may also utilize logical connections to one or more computing system environments. Communications between the computing system 600 and the remote computing system environment may be exchanged via a further processing device, such a network router 648, that is responsible for network routing. Communications with the network router 648 may be performed via a network interface component 644. Thus, within such a networked environment, e.g., the Internet, wide area network (WAN), local area network (LAN), or other like type of wired or wireless network, it will be appreciated that program modules depicted relative to the computing system 600, or portions thereof, may be stored in the memory storage device(s) of the computing system 600.

The computing system 600 may also include localization hardware 646 for determining a location of the computing system 600. In embodiments, the localization hardware 646 may include, for example only, a GPS antenna, an RFID chip or reader, a Wi-Fi antenna, or other computing hardware that may be used to capture or transmit signals that may be used to determine the location of the computing system 600.

Referring to FIG. 1, the user electronic device 103 may be a computing system 600. Additionally, the edge server 106, routing server 108, bot detection API 110, SDK services 112, and payments API 114 may each be a computing system 600 including, for example, the processing unit 602, system memory 604, ROM 608, RAM 610, network interface component 644, and storage (e.g., hard disk drive interface 612).

While this disclosure has described certain embodiments, it is understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, the subject technology is not limited to the specific details set forth herein and can be practiced using one or more other embodiments. In other instances, well known methods, procedures, components, and circuits have not been described in detail as not to unnecessarily obscure various aspects of the present disclosure. Additionally, in one or more embodiments, structures and components are shown in block diagram form to avoid obscuring the concepts of the subject technology.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It is understood, however, that these terms are to be interpreted as referencing physical manipulations and quantities and are merely convenient labels that should be interpreted further in view of terms commonly used in the art.

Unless specifically stated otherwise, as apparent from the discussion herein, it is understood that throughout discussions of the present embodiment, discussions utilizing terms such as “determining,” “outputting,” “transmitting,” “recording,” “locating,” “storing,” “displaying,” “receiving,” “recognizing,” “utilizing,” “generating,” “providing,” “accessing,” “checking,” “notifying,” “delivering,” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of any of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Headings and subheadings, if any, are used for convenience only and do not limit the subject disclosure.

What is claimed is:

1. A computer-implemented method comprising:
receiving, by a first computing system and from a second computing system, a request designating an endpoint, wherein the first computing system includes a kernel extension;
in response to receiving the request, triggering, by the first computing system, a function of the kernel extension, the function comprising:
determining a permission of the endpoint to receive unmodified data; and
modifying at least part of the request based on the determined permission; and
routing, by the first computing system, the request to a third computing system associated with the endpoint designated by the request.

2. The computer-implemented method of claim 1, further comprising, before receiving the request:
loading the kernel extension into a kernel space of the first computing system, wherein the kernel extension is obtained from a user space of the first computing system.

3. The computer-implemented method of claim 2, wherein loading the kernel extension into the kernel space comprises compiling the kernel extension into bytecode and verifying the bytecode.

4. The computer-implemented method of claim 2, wherein loading the kernel extension into the kernel space comprises updating a set of permissions in the kernel space, wherein the set of permissions is used to determine the permission of the endpoint to receive unmodified data.

5. The computer-implemented method of claim 2, wherein loading the kernel extension comprises attaching the function of the kernel extension to a system call associated with receiving the request.

6. The computer-implemented method of claim 1, wherein modifying at least part of the request comprises masking personally identifiable information.

7. The computer-implemented method of claim 6, wherein the personally identifiable information comprises a client device address.

8. The computer-implemented method of claim 6, wherein masking the personally identifiable information comprises hashing the personally identifiable information.

9. The computer-implemented method of claim 1, wherein modifying at least part of the request comprises replacing the at least part of the request with a modified version of the at least part of the request.

10. The computer-implemented method of claim 1, wherein the first computing system is an application-layer routing server, the second computing system is an edge server, and the third computing system is an endpoint server.

11. A computing system comprising:
a processor; and
a non-transitory computer-readable medium storing instructions that, when executed by the processor, cause the computing system to perform operations comprising:
obtaining, from a user space of the computing system, a programmable kernel extension comprising one or more functions;
attaching a function of the programmable kernel extension to one or more system calls of the computing system associated with receiving requests;
establishing a network connection with another computing system;
receiving, via the network connection and with a system call of the one or more system calls, a request comprising a header, the header designating an endpoint;
in response to receiving the request, modifying, by the function of the programmable kernel extension attached to the system call, the header of the request; and
routing the request based on the endpoint designated by the header.

12. The computing system of claim 11, wherein the programmable kernel extension executes in a sandbox environment that is logically separated from the one or more system calls of the computing system.

13. The computing system of claim 11, wherein modifying the header comprises masking personally identifiable information in the header.

14. The computing system of claim 13, wherein the personally identifiable information is an internet protocol address.

15. The computing system of claim 13, wherein masking the personally identifiable information comprises hashing the personally identifiable information.

16. The computing system of claim 13, wherein the operations further comprise, in response to modifying the header of the request, replacing the header of the request with the modified header.

17. The computing system of claim 11, wherein modifying the header of the request is further in response to the endpoint being unauthorized to receive the header without modification.

18. A method comprising:
obtaining, in a user space of a first computing system, a kernel extension comprising a function;
loading the kernel extension into a kernel space of the first computing system;
receiving, from a second computing system, a request designating an endpoint;
in response to receiving the request, modifying at least part of the request based on the function of the kernel extension; and
transmitting the request to a third computing system associated with the endpoint designated by the request.

19. The method of claim 18, wherein modifying the request is further in response to the endpoint being unauthorized to receive the request without modification.

20. The method of claim 18, wherein the receiving, modifying, and transmitting are performed in the kernel space.
